(19) United States
(12) Patent Application Publication
(10) Pub. No.: US 2006/0265692 A1
(43) Pub. Date: Nov. 23, 2006

(54) Method, apparatus, and computer program product for code patching

(76) Inventor: Mengjin Su, Corvallis, OR (US)

Correspondence Address: AVAGO TECHNOLOGIES, LTD., P.O. BOX 1920, DENVER, CO, 80201-1920, US

(21) Appl. No.: 11/133,409

(22) Filed: May 20, 2005

(51) Int. Cl. G06F 9/44

(52) U.S. Cl. 717/124

(57) ABSTRACT

A method and computer readable medium encoded with processing instructions for controlling a computer to implement a method for patching code. In an embodiment, the method includes testing status of a patch flag to determine a patching condition and executing a patch vector including a plurality of patch code segments respectively corresponding to a plurality of patch points when said testing determines that the patching condition is true.

### BACKGROUND OF THE INVENTION

### Description of the Related Art

Often, computer program code includes problems in particular sections of the program. These problems are known as computer bugs, faults, or defects. Such problems can be caused by a programming mistake in the logic of a code section. For example, a computer programmer may inadvertently neglect to account for a particular condition encountered during execution of the program code. As a result, the program could “freeze” or cease executing, as the program lacks instruction regarding how to handle the unexpected condition in such a situation. Such problems can lead to major problems with the program and should be corrected when discovered. In addition to the aforestated problems, a computer program may require updating to allow the program to execute in a more robust and/or efficient manner. Similarly, increased functionality of a computer program may also be desired.

Regardless of whether the computer program requires correction or updating, repairing the computer program code can be difficult when it is embedded into a silicon computer chip. Often, the program code is “ROMed” into the silicon computer chip. As the program code is ROMed instead of “flashed into the silicon computer chip,” the program code cannot be altered after the computer chip is made. As an alternative to replacing the chip with a newer version, which can be cost ineffective, a patch code segment can be installed in the problematic section of program code.

A patch code segment is a section or piece of code that can be downloaded to Random Access Memory (RAM), for example, to replace execution of problematic code sections in the program code. The RAM area holding the patch code segment is typically located in the space of the computer program code to be patched. The program code to be patched typically includes one or more patch points that allow a patch code segment or patch code segments to be inserted at a later time, for example. A patch point typically includes a condition check and an instruction to be followed based on the condition. For example, a patch point can include a condition check followed by a conditional branch instruction that branches to the corresponding patch code. As discussed herein, “ROMed” program code, including the patch point(s), cannot be altered. That is, the conditional branch instruction in the patch point contains a fixed target address—a vector address.

Now referring to FIG. 1, a prior art system, a computer program 100 to be patched includes a first patch point 105. The first patch point 105 is associated with a patch flag 110 and a patch vector 115. In addition, the computer program 100 can also include a last patch point 120. The last patch point 120 is associated with a patch flag 125 and a patch vector 130. At each patch point, for example, at patch point 105, an associated patch flag, for example patch flag 110, is tested. Depending on results of the tested patch flag, an associated patch vector, for example, patch vector 115 is executed and a code patch segment, for example, code patch section 117, is inserted at the affected patch point.

More specifically, the patch point 105 is followed by a problematic code section. In some situations, however, the problematic code section can be at the patch point or before the patch point. In such an instance, associated patch flag 110 can be checked or tested to determine if a code patch segment should be activated. Both patch vector 115 and its relevant code patch section 117 need to be downloaded to the corresponding RAM area. If the testing of the patch flag 110 determines that the code patch segment should be installed, a conditional jump instruction can be executed, thereby transferring program control to patch vector 115 and installing the code patch section. Similarly, if testing of patch flag 125 at last patch point 120 determines that code patch section 131 should be installed, another jump instruction can be executed, thereby transferring program control to patch vector 130 associated with last patch point 120 and patch flag 125, and so forth for each patch point in the computer program 100 (to determine if execution switching and code patching is required).

Thus, the computer program 100, for example, may include several patch points, each patch point having its own associated patch flag and patch vector. As more patch points are needed in the computer program 100, more patch flags and more patch vectors are needed. As the patch vectors are stored in a vector table, if there are N patch points embedded into the program, then the vector table will be N words long (given that each patch vector occupies one word in memory). A program including a plurality of patch points can lead to multiple problems due to its number of patch points.

For example, regardless of how many patch vectors are employed or active, the vector table cannot be used for purposes unrelated to code patching. As the vector table is typically located in RAM, a program including multiple patch vectors can result in a requirement for a large RAM space, which can be cost ineffective. Further, the multiple patch vectors can greatly occupy the RAM space and limit the space that can be used for the patch code. Moreover, as patch flags and patch vectors are strictly coupled, unmatched instances of patch flags and patch vectors must be avoided to prevent disturbance of code patching for the computer program. Thus, design of a patch code method such as that described in the text accompanying prior art FIG. 1, can be difficult.

In light of the foregoing problems, there is a need for a cost effective and easier method of patching computer program code that can allow a RAM space to be more efficiently utilized.

### BRIEF DESCRIPTION OF THE DRAWINGS

Aspects and advantages of the invention will become apparent and more readily appreciated from the following description of the embodiments, taken in conjunction with the accompanying drawings of which:

FIG. 1 is an illustration of a configuration of elements involved in a method for patching program code, according to a prior art method.

FIG. 2 is an illustration of a configuration of elements involved in a method for patching program code, according to an embodiment of the present invention.

FIG. 3 is a flow chart of a general method for patching program code, according to an embodiment of the present invention.

FIG. 4 is a flow chart of a method for executing a patch vector involved in the general method for patching program code according to the embodiment of the present invention displayed in FIG. 3.

FIG. 5 is a flow chart of a specific method for patching program code, according to an embodiment of the present invention.

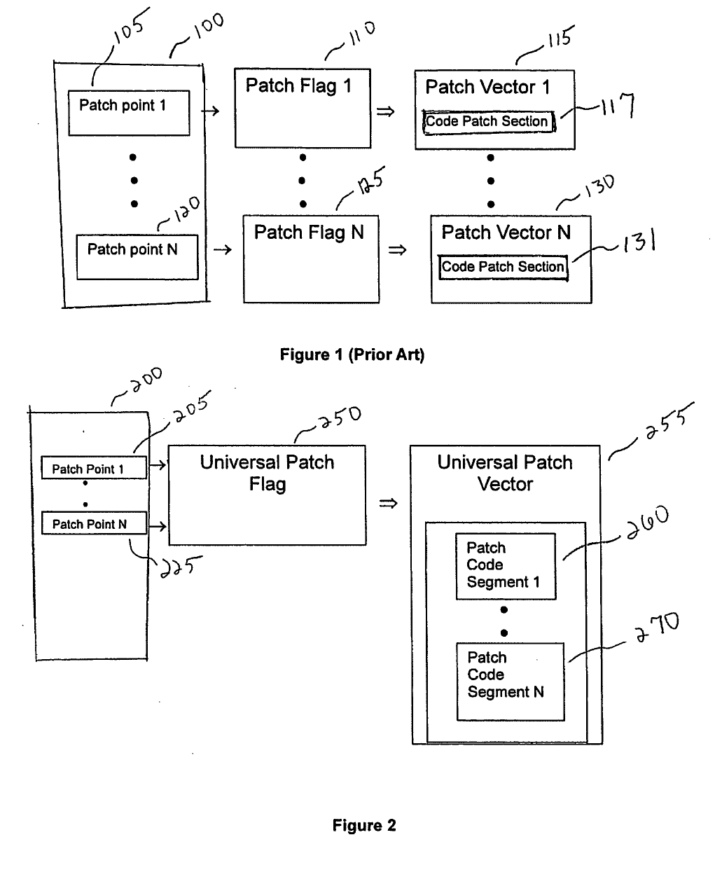

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

FIG. 2 is an illustration of a configuration of elements involved in a method for program code patching, according to an embodiment of the present invention. In such an embodiment, the computer program 200 can include a first patch point 205 and a last patch point 225. After being presented with the disclosure herein, one of ordinary skill in the art will appreciate that the computer program 200 can include a plurality of other patch points. Regardless of the number of patch points in the computer program 200, however, each patch point is associated with the same universal patch flag 250, for example, and the same universal patch vector 255, for example. The universal patch flag 250 and its associated universal patch vector 255 are universal in the sense that they are associated with each patch point in the computer program 200.

In particular, for example, first patch point 205 is associated with universal patch flag 250 and universal patch vector 255. Although a second patch point (not shown in FIG. 2) is a different patch point, the second patch point is also associated with the same universal patch flag 250 and the same universal patch vector 255. Likewise, last patch point 225 is also associated with the same universal patch flag 250 and the same universal patch vector 255.

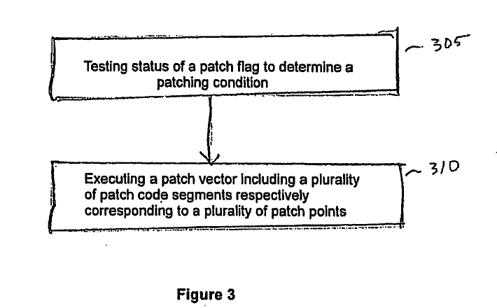

In the embodiment of the invention shown in FIG. 2, the universal patch vector includes a plurality of patch code segments, for example, patch code segment 260 through patch code segment 270. For example, in an embodiment of the invention, the universal patch vector 255 is a fixed location in memory. Each patch code segment, for example, patch code segment 260, corresponds to a particular patch point. For example, patch code segment 260 corresponds to first patch point 205 in the embodiment of the invention illustrated in FIG. 2. Similarly, patch code segment 270 corresponds to last patch point 225, as illustrated in FIG. 2. Operation of the method of program code patching will be described in conjunction with FIG. 3.

FIG. 3 is a flow chart of a general method for program code patching, according to an embodiment of the present invention. FIG. 3 is a general overview of the method of the invention, which includes testing a universal patch flag and executing a universal patch vector when the testing supports execution. Operation 305 of FIG. 3 includes testing status of a patch flag to determine a patching condition. In an embodiment of the invention, the testing in operation 305 determines the patching condition at a plurality of patch points throughout a program to be patched. For example, in an embodiment, the patch flag is represented by a bit having a value of true or false. It should be understood, however, that the bit can have any other value indicating whether it is set or not set. In an embodiment of the invention, the bit serves as means for testing status of the patch flag to determine a patching condition.

The patch flag can be a variable, for instance, having a status value of true or false. In such an embodiment, a branch test instruction such as an “if” statement can be utilized to test the patch flag to determine its value. It should be noted that regardless of the patch point encountered, for example, first patch point 205 or last patch point 225, the status of the same patch flag is tested. If the testing determines that the patch flag is false, program control resumes, without executing the patch vector. In other words, executing the patch vector is prevented when the testing determines that the patching condition is false. For example, in an embodiment of the present invention, if the testing determines that the patch flag is false, a jump instruction can be executed to jump to an address after the patch point to prevent execution of the patch vector. In an embodiment of the invention, the jump instructions serves as means for executing the patch vector including a plurality of patch code segments respectively corresponding to a plurality of patch code points when said testing determines the patching condition is true. If the testing performed in operation 305 determines that the patch flag is true, processing continues with operation 310, which will be described further herein below.

In an embodiment of the present invention, after operation 305 is performed and before operation 310 is performed, that is, prior to executing the patch vector, a patch point return address corresponding to a patch point from which program control originated is established. The purpose of establishing the return address is to allow the patch vector that will be executed in operation 310 to determine a patch point from which program control was transferred, as will be explained in further detail below. After being presented with the disclosure herein, however, one of ordinary skill in the art will realize that the return address can also be established by other methods, without departing from the spirit and scope of the present invention. Referring again to FIG. 3, from operation 305, the method resumes with operation 310.

Operation 310 includes executing a patch vector including a plurality of patch code segments respectively corresponding to a plurality of patch points. For example, in an embodiment, a jump instruction can be executed to jump to the patch vector, which can be at a fixed location in a memory. Regardless of the patch point from which program control was transferred, for example, first patch point 105 or last patch point 120, the same patch vector is executed in operation 310 if the testing in operation 305 determines that the patch flag's status is true.

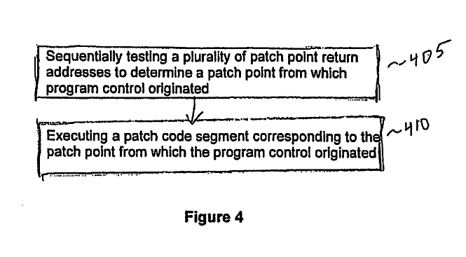

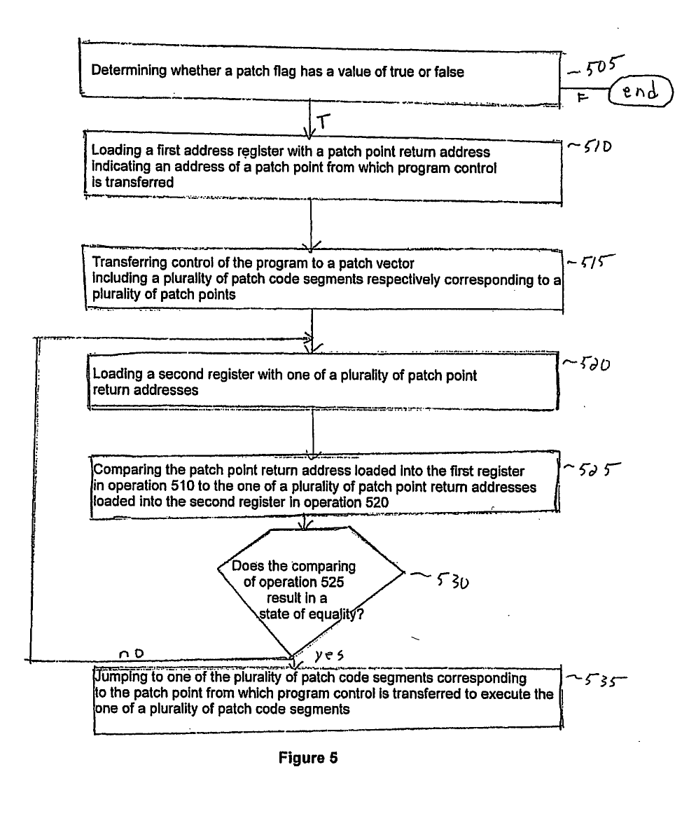

FIG. 4 is a flow chart of a method for executing a patch vector involved in the general method for patching program code according to the embodiment of the present invention described in FIG. 3. That is, FIG. 4 is a flow chart of the operations involved in operation 310 of FIG. 3. FIG. 4 will be used in conjunction with FIG. 2 to describe embodiments of invention. Referring to FIG. 4, operation 405 includes sequentially testing a plurality of patch point return addresses to determine a patch point from which program control originated. For example, in an embodiment of the present invention the testing the plurality of patch point return addresses includes comparing one of the plurality of patch point return addresses with a patch point return address corresponding to the patch point from which the program control originated. In other words, the return address that was established after operation 305 in FIG. 3, the return address for first patch point 105, for example, is compared to a plurality of return addresses, including the return address from which program control originated, for example, a second patch point, a third patch point, and a fourth patch point, and so forth.

In an embodiment of the present invention, testing the return address of the patch point from which program control was transferred is compared to the return address of first patch point 205 (FIG. 2), for example. If the return address of the patch point from which program control was transferred is equal to the return address of the first patch point 205, for example, then a conclusion can be drawn that program control was transferred from the first patch point 205. In an embodiment of the present invention, the comparison is determined by a compare instruction. After being presented with the disclosure herein, however, one of ordinary skill in the relevant art will realize that a variety of other methods may be utilized to perform the comparison without departing from the scope and spirit of the present invention. If it is determined that the program control was transferred from the first patch point 205, for example, the process resumes with operation 410.

Operation 410 includes executing a patch code segment corresponding to the patch point from which the program control originated. For example, a jump instruction can be used to jump from the universal patch vector 250 (FIG. 2) to the particular patch code segment associated with the particular patch point, thereby patching the program code. In the example above, the patch code segment associated with first patch point 205, that is, patch code segment 260, is executed, thereby patching the program code at the first patch point 205.

In an embodiment of the present invention, operation 405 and 410 are repeated for each patch point in the program code. For example, if the return address from which program control was transferred is equal to the return address of the last patch point 225, for example, then a conclusion can be drawn that program control was transferred from the last patch point of the program. In such an instance, when the return address from which program control was transferred, that is, the return address of the last patch point 225, is compared with the return address of the first patch point 205, the comparison will result in a value of false, as the two return addresses are not equal. In such an instance, operation 410 will not be performed at this time.

The return address from which program control was transferred is then compared to the return address of the last patch point 225. When the return address from which program control was transferred, that is, the return address of the last patch point 225 in the above example, is equal to the return address of the last patch point 225, operation 410 is again performed. In such an instance, however, operation 410 includes executing a patch code segment corresponding to the last patch point 225, thereby patching the program code at the last patch point 225, as the return address values are one in the same.

The operations described above are repeated for each patch point in the program. Thus, the return address of each patch point in the program is compared with the first patch point, the second patch point, the third patch point, and so forth, until the testing in operation 405 determines a patch point from which program control originated. When the testing determines the patch point from which program control was transferred, operation 410 is performed, thereby executing a patch code segment corresponding to the particular patch point from which program control was transferred. If the testing of operation 405 determines that not all comparisons result in a false value, then the executing in operation 410 is replaced with returning program control to the patch point from which the program control originated when the patch is unnecessary.

Regardless of the patch point from which program control was transferred, the same patch vector is executed for each of the plurality of patch points. Therefore, the vector table includes a single patch flag and a single patch vector. As a result, design of the code patching is easier to implement, as one need not be concerned with matching each patch point with a patch flag and a patch vector. Moreover, code patching can be accomplished more efficiently, as a reasonable sized vector table is maintained, as the method for patching code of a program includes controlling execution of a plurality of patch code segments via a single flag and a single vector in an embodiment of the invention.

FIG. 5 is a flow chart of a specific method for program code patching, according to an embodiment of the present invention in which address registers are utilized. Referring to FIG. 5, operation 505 includes determining whether a patch flag has a value of true or false. If the patch flag is determined to have a value of false, operation 510 is not executed and the method for program code patching ends, that is, the method is not executed. In operation 505, if the patch flag has a value of true, the method resumes with operation 510.

Operation 510 includes loading a first address register with a patch point return address indicating an address of a patch point from which program control is transferred before program control reached the patch vector. In an embodiment of the invention, the first address register serves as means for storing the patch point return address from which program control originated. From operation 510, the method resumes with operation 515.

Operation 515 includes transferring control of the program to a patch vector including a plurality of patch code segments respectively corresponding to a plurality of patch points. From operation 515, the method resumes with operation 520. Operation 520 includes loading a second register with one of a plurality of patch point return addresses. For example, the second register is initially loaded with a return address of the first patch point of the program to be patched in an embodiment of the invention, subsequently followed by return addresses for the second patch point, the third patch point, the forth patch point and so forth. Thus, the second address register serves as a counter register by sequentially storing the first patch point return addresses, the second patch point return addresses, and so forth. In an embodiment, of the invention, the second address register serves as means for sequentially storing one of a plurality of additional patch point return addresses. From operation 520, the method resumes with operation 525.

Operation 525 includes comparing the patch point return address loaded into the first register in operation 510 with (the patch point return address indicating an address of a patch point from which program control is transferred) the one of a plurality of patch point return addresses loaded into the second register in operation 520.

For example, if program control was transferred from the return address of the first patch point 205 (FIG. 2), the return address of the first patch point 205 is compared to the return address of the first patch point 205, the return address of the second patch point, the return address of the third patch point (not shown in figures), and so forth, for the remainder of the patch points, until the comparison determines a matching return address.

For example, if program control was transferred from the first patch point, the value stored in the first address register (the return address of the first patch point) is compared with the value stored in the second address register (the return address of the first patch point). As another example, if program control was transferred from the fifth patch point, the value stored in the first address register (the return address of the fifth patch point) would be compared with the value stored in the second address register, which would initially be the return address of the first patch point. Providing that the values stored in the first and second address registers are not equal to each other, the value stored in the first address register would then be compared with the return address of the second patch point, which would be loaded into the second address register, followed by comparison with the return address of the third patch point, which would be loaded into the second address register, and so forth for additional patch point return addresses, continuing in a sequential, counting manner until the return address of the fifth patch point is loaded into the second address register.

In an embodiment of the invention, a compare instruction serves as means for comparing one of the plurality of additional patch point return addresses with the patch point return address from which program control originated to determine if said one of the plurality of additional patch point return addresses matches the patch point return address from which the program control originated. After being presented with the disclosure herein, however, one skilled in the relevant art will realize that the comparison can be performed by a variety of other tools and/or method, without departing from the scope and spirit of the present invention. After each comparison as described in operation 525 is performed, operation 530 is performed to determine if the return address value in the first address register equals the return address value in the second address register.

In operation 530, if the comparing of operation 525 does not result in a state of equality, then operations 520 and 525 are repeated. In operation 530, if the comparing of operation 525 results in a state of equality, then the method resumes with operation 535.

Operation 535 includes jumping to one of the plurality of patch code segments corresponding to the patch point from which program control is transferred to execute the one of a plurality of patch code segments. In continuing with the last example above, as the comparison determined that control was transferred from the fifth patch point, in operation 530, patch code corresponding to the fifth patch point is “jumped to” to execute the patch code to patch the program at the fifth patch point. In an embodiment of the present invention, a jump instruction serves as means for executing patch code when one of the plurality of additional patch point return addresses is same as the patch point return address from which the program control originated.

After being presented with the disclosure herein, one of ordinary skill in the art will realize that the method for patching program code according to the present invention can be implemented in any viable programming languages such as C, C++, other high-level programming languages, and/or low level programming languages such as Assembler, for example. Further, the present invention can be employed to patch program code written in any viable computer programming languages. Therefore, the present invention is not limited to being implemented in any specific language.

The present invention can also be in the form of a computer readable medium encoded with processing instructions for controlling a computer to implement the methods described herein according to embodiments of the present invention. It should also be understood that although the present invention was described in terms of a method, the invention can be employed via an apparatus.

The present invention should not be limited to the embodiments described herein. After being presented with the disclosure herein, those of ordinary skill in the art would appreciate that changes may be made to the disclosed embodiments without departing from the spirit and scope of the present invention.

What is claimed is:

1. A computer readable medium encoded with processing instructions for controlling a computer to implement a method, comprising:
testing status of a patch flag to determine a patching condition; and
executing a patch vector including a plurality of patch code segments respectively corresponding to a plurality of patch points when said testing determines that the patching condition is true.

2. The computer readable medium of claim 1, wherein said testing determines the patching condition at the plurality of patch points throughout a program to be patched.

3. The computer readable medium of claim 1, wherein said executing is prevented when said testing determines that the patching condition is false.

4. The computer readable medium of claim 1, further comprising, prior to said executing, establishing a patch point return address corresponding to a patch point from which program control originated.

5. The computer readable medium of claim 1, wherein said executing includes:
sequentially testing a plurality of patch point return addresses to determine a patch point from which program control originated; and
executing a patch code segment corresponding to the patch point from which the program control originated when said testing determines that said one of the plurality of patch point return addresses are equal to the return address corresponding to the patch point from which the program control originated.

6. The computer readable medium of claim 5, wherein said testing the plurality of patch point return addresses includes comparing one of the plurality of patch point return addresses with a patch point return address corresponding to the patch point from which the program control originated.

7. The computer readable medium of claim 5, further comprising, in which said executing is replaced with returning program control to the patch point from which the program control originated when a patch is unnecessary.

8. The computer readable medium of claim 2, wherein the method is implemented in a programming language known as C.

9. The computer readable medium of claim 2, wherein the method is implemented in a programming language known as C++.

10. The computer readable medium of claim 2, wherein the method is implemented in a high-level programming language.

11. The computer readable medium of claim 2, wherein the method is implemented in a low-level programming language.

12. A method for patching code of a program, comprising controlling execution of a plurality of patch code segments via a single flag and a single vector.

13. A computer readable medium encoded with processing instructions for causing a computer to implement a method, comprising:
testing a universal patch flag; and
executing a universal patch vector when the testing supports execution.

14. An apparatus, comprising:
means for testing status of a patch flag to determine a patching condition; and
means for executing a patch vector including a plurality of patch code segments respectively corresponding to a plurality of patch code points when said testing determines that the patching condition is true.

15. The apparatus of claim 14, further comprising:
means for storing a patch point return address from which program control originated; and
means for sequentially storing one of a plurality of additional patch point return addresses.

16. The apparatus of claim 15, further comprising means for comparing said one of a plurality of additional patch point return addresses with said patch point return address from which program control originated to determine if said one of said plurality of additional patch point return addresses matches said patch point return address from which the program control originated.

17. The apparatus of claim 16, further comprising means for executing patch code when said one of a plurality of additional patch point return addresses is same as said patch point return address from which the program control originated.

18. A computer readable medium encoded with processing instructions for controlling a computer to implement a method to patch a program, comprising:
determining whether a patch flag has a value of true or false;
loading a first address register with a patch point return address indicating an address of a patch point from which program control is transferred;
transferring control of the program to a patch vector including a plurality of patch code segments respectively corresponding to a plurality of patch points when said determining determines that the patch flag has a value of true;
loading a second register with one of a plurality of patch point return addresses;
comparing the patch point return address indicating an address of a patch point from which program control is transferred to the one of a plurality of patch point return addresses; and
jumping to one of said plurality of patch code segments corresponding to the patch point from which program control is transferred when said comparing indicates that the patch point return address of a patch point from which program control is transferred is equal to the one of the plurality of patch point return addresses loaded into the second register.
